(19) United States
(12) Patent Application Publication
(10) Pub. No.: US 2019/0169038 A1
(43) Pub. Date: Jun. 6, 2019

(54) Process For The Conversion Of Lithium Phosphate Into A Low Phosphate Lithium Solution Suitable As Feedstock For The Production Of Saleable Lithium Products And For The Recovery Of Phosphorous For Re-Use In The Production Of Lithium Phosphate

(71) Applicants: LITHIUM EXTRACTION TECHNOLOGIES (AUSTRALIA) PTY LTD, Sydney NSW (AU); AUSTRALIAN NUCLEAR SCIENCE AND TECHNOLOGY ORGANISATION, Lucas Height NSW (AU)

(72) Inventors: Cameron STANTON, New South Wales (AU); John LAWSON, New South Wales (AU); Paul FREEMAN, New South Wales (AU); Suzanne BURLING, New South Wales (AU)

(73) Assignees: LITHIUM EXTRACTION TECHNOLOGIES (AUSTRALIA) PTY LT D, Sydney NSW (AU); AUSTRALIAN NUCLEAR SCIENCE AND TECHNOLOGY ORGANISATION, Lucas Height NSW (AU)

(21) Appl. No.: 16/324,065

(22) PCT Filed: Aug. 8, 2017
(86) PCT No.: PCT/AU2017/050835

§ 371 Date: Feb. 7, 2019

Related U.S. Application Data
(60) Provisional application No. 62/372,018, filed on Aug. 8, 2016.

(51) Int. Cl. C01D 15/02; C01B 25/37; C01B 25/34; C01G 49/02; C01F 5/22; C01F 17/00; C22B 3/44; C22B 26/12; C22B 3/10

(52) U.S. Cl. CPC C01D 15/02; C01B 25/375; C01B 25/34; C01B 25/37; C22B 3/10; C01F 5/22; C01F 17/0043; C22B 3/44; C22B 26/12; C01G 49/02

(57) ABSTRACT

Some aspects of the present disclosure relate to systems and processes for the conversion of lithium phosphate into a low-phosphate solution containing lithium which may be suitable as feedstock for the production of saleable lithium products.

### FIELD

The present disclosure relates to a process for the conversion of lithium phosphate into a low phosphate lithium solution which is suitable as feedstock for the production of saleable lithium products, such as lithium carbonate or lithium hydroxide. Embodiments of the disclosure allow the recovery of phosphate from the lithium phosphate either for re-use to produce more lithium phosphate, or for other purposes and/or for the recovery and re-use of residual phosphate from a solution depleted of lithium after separation of lithium phosphate from the solution. The present disclosure is particularly, though not exclusively, suitable for the conversion of lithium phosphate that has been precipitated and separated from a natural brine, either concentrated by evaporation or not, although it is to be appreciated that the present disclosure may have application for the conversion of any lithium phosphate feedstock.

### BACKGROUND

Any discussion of the prior art throughout the specification should in no way be considered as an admission that such prior art is widely known or forms part of common general knowledge in the field.

Lithium and lithium compounds are becoming increasingly important for use in various industries such as the electronic, pharmaceutical, ceramic and lubricant industries, and, particularly, for use in high performance lithium batteries. Lithium can be recovered from a variety of sources including mineral sources such as spodumene, petalite and lepidolite, seawater and from brines containing lithium such as those found in Salars in the Andes Mountains of South America. Examples of lithium Salars include the Salar de Uyani in Bolivia and the Salar de Rincon in Argentina. The term “brine” as used in this description means water (H₂O) containing dissolved ions including brines containing lithium salts and those that may include ions from other mineral salts such as sodium, potassium, calcium, magnesium, chloride, bromide, boron, iodide, sulphate and carbonate.

Due to the relative insolubility of lithium phosphate the treatment of a lithium containing solution with a phosphorus supplying material can enable the recovery of lithium from brines which contain low concentrations of lithium, for example natural brines from Salars. The precipitation of lithium as the phosphate can mean that the use of expensive and time-consuming solar evaporation processes to concentrate the brine are avoided. Once formed, the lithium contained in the lithium phosphate must converted into a form for which there is a demand in the marketplace, for example, lithium carbonate or lithium hydroxide.

Hitherto, processes for the recovery of lithium using phosphate precipitation have been characterised as being cost inefficient due to their consumption of phosphorus supplying reagent and because phosphorus containing reagents are expensive. Such processes have also been characterised as being environmentally unsound due to the release of phosphates into the environment.

It is an object of the present invention to overcome or ameliorate at least one of the disadvantages of the prior art, or to provide a useful alternative.

Preferred embodiments of the present disclosure seek to ameliorate some of the drawbacks of recovering lithium from a lithium containing solution, such as a lithium containing brine, employing a phosphorus supplying material.

### SUMMARY

The present disclosure provides a process for the conversion of lithium phosphate into a low-phosphate solution containing lithium which is suitable as feedstock for the production of saleable lithium products, the process includes: dissolving the lithium phosphate in acid to form an acidic lithium phosphate bearing solution; treating the acidic lithium phosphate bearing solution with the hydroxide of a phosphate carrier to form a precipitate of phosphate and the phosphate carrier; and separating the precipitate of phosphate and the phosphate carrier leaving a low-phosphate solution containing lithium.

In an embodiment, the low-phosphate solution containing lithium preferably comprises a solution containing phosphorus in a concentration of less than about 10 mg/L. For example, the phosphorus may be in a concentration of about 1 mg/L, 2 mg/L, 3 mg/L, 4 mg/L, 5 mg/L, 6 mg/L, 7 mg/L, 8 mg/L, 9 mg/L, 10 mg/L, or any concentration therebetween. The term “phosphate carrier”, as it is used throughout this specification, refers to an ion that forms an insoluble phosphate compound within a certain pH range, and that releases the phosphate to form a hydroxide at a higher pH, for example when treated with sodium hydroxide (i.e. caustic soda). Examples of such phosphate carriers include Fe(III) and Mg(II), with Fe(III) being preferred, although other ions could be used that behave in a similar fashion.

In some embodiments, the process further includes treating the precipitate of phosphate and the phosphate carrier with a hydroxide base to convert the phosphate carrier to a precipitate of hydroxide and the phosphate carrier. In an embodiment, the treatment with the hydroxide base is conducted in a single stage. In alternative embodiments, this treatment is conducted in two or more stages.

In an embodiment, the treatment with the hydroxide base is carried out at a temperature higher than ambient temperature. Preferably, the treatment with the hydroxide base is carried out at a temperature about 70° C. to about 200° C. More preferably, the treatment with the hydroxide base is carried out at a temperature at about 75° C. to about 150° C. Even more preferably, the treatment with the hydroxide base is carried out at a temperature at about 80° C. to about 100° C. For example, the temperature may be 70° C., 75° C., 80° C., 85° C., 90° C., 95° C., 100° C., 110° C., 120° C., 130° C., 140° C., 150° C., 160° C., 170° C., 180° C., 190° C. or 200° C., or any temperature therebetween.

In an embodiment, the treatment with the hydroxide base is carried out at an acidic pH. Preferably, the treatment with the hydroxide base is carried out at a pH is <2.75. More preferably, the treatment with the hydroxide base is carried out at a pH in the range of 1.25 to 2.75, or even more preferably a pH in the range of 2.25 to 2.75. For example, the pH may be pH 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7 or 2.75, or any pH therebetween.

In a preferable embodiment, the treatment with the hydroxide base is carried out in two stages.

In a two stage treatment embodiment, the first stage and/or the second stage of treatment with the hydroxide base are preferably carried out at a temperature higher than ambient temperature. More preferably, the first stage and/or the second stage of treatment with the hydroxide base are carried out at a temperature about 70° C. to about 200° C. Even more preferably, the first stage and/or the second stage of treatment with the hydroxide base are carried out at a temperature about 75° C. to about 150° C. Still more preferably, the first stage and/or the second stage of treatment with the hydroxide base are carried out at a temperature about 80° C. to about 100° C. For example, the temperature of the first stage and/or the second stage may be 70° C., 75° C., 80° C., 85° C., 90° C., 95° C., 100° C., 110° C., 120° C., 130° C., 140° C., 150° C., 160° C., 170° C., 180° C., 190° C. or 200° C., or any temperature therebetween.

In a two stage treatment embodiment, the first stage and/or the second stage of treatment with the hydroxide base are preferably carried out at an acidic pH. More preferably, the first stage and/or the second stage of treatment with the hydroxide base are carried out at a pH<2.75. Preferably, the pH in the first stage is controlled in a range of about pH 1.25 to 1.5. Further preferably, the pH in the second stage is controlled to a pH greater than the pH of the first stage. Most preferably, the pH of the second stage is controlled to a range of about pH 2.25 to 2.75.

For example, the pH of the first stage and/or the second stage in embodiments may be pH 1.25, 1.3, 1.35, 1.4, 1.45, 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7 or 2.75, or any pH therebetween.

In a particular embodiment, the treatment with the hydroxide base is carried out in two stages at about 80° C. to about 100° C., and preferably about 80° C., wherein the pH in the first stage is preferably controlled in a range of about pH 1.25 to 1.5, and the pH in the second stage is preferably controlled to a higher pH.

Preferably, the pH of the second stage is controlled to be less than or equal to the hydrolysis pH of the phosphate carrier ion, in order to maintain reactivity of the phosphate carrier. If the phosphate carrier ion is Fe(III) then the desired pH range in the second stage is about pH 2.25 to 2.75, for example, pH 2.25, 2.3, 2.35, 2.4, 2.45, 2.5, 2.55, 2.6, 2.65, 2.7, 2.75, or any pH therebetween. If the phosphate carrier ion is Mg(II) then the desired pH range in the second stage is less than about 4, for example pH 0, 0.5, 1, 1.5, 2, 2.5, 3, 3.5, 4, or any pH therebetween.

Preferably, the step of treating the precipitate of phosphate and the phosphate carrier with a hydroxide base releases the phosphate into solution for re-use in a process to produce lithium phosphate.

Accordingly, the aforementioned embodiments of the disclosure are advantageous in that they take advantage of the propensity of selected phosphate carrier ions to form a relatively insoluble phosphate precipitate at a relatively low pH and its ability to be released into solution, preferably by causticisation, at a relatively high pH, whereby the phosphate ions in solution are made available for reuse for producing more lithium phosphate.

In some embodiments, the precipitate of hydroxide and the phosphate carrier is separated and at least some of the phosphate carrier is re-used in the step of treating the acidic lithium phosphate bearing solution to form the precipitate of phosphate and the phosphate carrier.

In some embodiments, the precipitate of hydroxide and the phosphate carrier is separated and at least some of the phosphate carrier is dissolved in acid to form a solution containing ions of the phosphate carrier.

Preferably, the solution containing the phosphate carrier ions is used to treat a solution containing residual phosphate ions from which the lithium phosphate is separated before being dissolved in acid, whereby the phosphate carrier ions form a precipitate with the residual phosphate ions.

Preferably, the solution containing residual phosphate ions is a brine and the precipitate of the residual phosphate ions and the phosphate carrier ions is separated from the brine, thereby leaving the brine substantially phosphate free, or containing an acceptably low concentration of phosphate ions. Optionally, the substantially phosphate free and lithium depleted brine can then be returned to the environment.

Accordingly, some of the aforementioned embodiments of the disclosure are advantageous in that they provide a process in which some of the phosphate carrier ions are recovered and reused to treat the acidic lithium phosphate bearing solution. Some of the aforementioned embodiments of the disclosure are advantageous in that they provide a process in which some of the phosphate carrier ions are recovered and reused to recover residual phosphate ions from a brine that has been depleted of lithium by the addition of a phosphorus supplying material.

Preferably, the precipitate of the residual phosphate ions and the phosphate carrier ions separated from the brine is treated with the hydroxide base. Preferably, the precipitate of the residual phosphate ions and the phosphate carrier ions separated from the brine is treated with the hydroxide base along with the precipitate of phosphate and the phosphate carrier recovered from the acidic lithium phosphate bearing solution.

The phosphate carrier preferably comprises an ion that forms an insoluble phosphate compound within a certain pH range (i.e. a relatively lower pH range) and that releases the phosphate and forms an insoluble hydroxide compound at a relatively higher pH.

Preferably, the phosphate carrier ion is iron. More preferably, the phosphate carrier ion is iron (III). In another embodiment, the phosphate carrier ion is magnesium (II). Iron (III) is the most preferred phosphate carrier ion because it has been found that the low pH at which it precipitates phosphorous leads to a precipitate less contaminated with other phosphate species, and/or because it has been found that Fe(III) can be more easily converted from the phosphate form to the hydroxide form. It is to be appreciated, however, that the invention may utilise other ions which behave in a similar fashion, for example, Mg(II) and the cations of rare earth elements. Accordingly, in other embodiments, the phosphate carrier ion is Lanthanum (III) or includes cations of any of the other rare earth elements Scandium, Yttrium, Cerium, Praseodymium, Neodymium, Promethium, Samarium, Europium, Gadolinium, Terbium, Dysprosium, Holmium, Erbium, Thulium, Ytterbium and Lutetium.

The present disclosure also provides a product produced by the abovementioned process.

Embodiments of the present disclosure provide processes for the conversion of lithium phosphate into a low phosphate (i.e. <10 mg/L) containing lithium solution which is suitable as feedstock for the production of saleable lithium products, and for the recovery of the phosphate either for re-use to precipitate more lithium phosphate, or for other purposes.

Embodiments of the present disclosure may also include a process for the conversion of lithium phosphate into a low-phosphate solution as described herein, including a process with each and every novel feature or combination of features disclosed herein. A system is also disclosed for the conversion of lithium phosphate into a low-phosphate solution as described herein, including a system with each and every novel feature or combination of features disclosed herein. Other aspects and features according to the disclosed technology will become apparent to those of ordinary skill in the art, upon reviewing the following detailed description in conjunction with the accompanying figures.

### BRIEF DESCRIPTION OF THE FIGURES

The disclosure will now be described in more detail below with reference to embodiments illustrated in the accompanying figures, wherein:

FIG. 1 illustrates a schematic representation of a phosphate precipitation, conversion and recovery process employing Fe(III) as a phosphate carrier within a process for the separation of phosphate from a solution containing lithium for use as feedstock for the production of saleable lithium products;

FIG. 2 illustrates a schematic representation of a process and plant for the separation of phosphate from a solution containing lithium for use as feedstock for the production of saleable lithium products, the process employing the phosphate precipitation, conversion and recovery process illustrated in FIG. 1 wherein Fe(III) is employed as a phosphate carrier; and

FIG. 3 illustrates a flowchart of a process the conversion of lithium phosphate into a low-phosphate solution containing lithium which is suitable as feedstock for the production of saleable lithium products in accordance with an embodiment of the disclosure.

FIG. 4 illustrates a quantitative graph demonstrating the efficacy of iron hydroxide as the phosphate carrier.

FIG. 5 illustrates a quantitative graph demonstrating the efficacy of magnesium hydroxide as the phosphate carrier.

FIG. 6 illustrates a quantitative graph demonstrating the optimisation of phosphate recovery conditions.

### DETAILED DESCRIPTION

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a”, “an” and “the” include plural referents unless the context clearly dictates otherwise. Ranges may be expressed herein as from “about” or “approximately” one particular value and/or to “about” or “approximately” another particular value. When such a range is expressed, other example embodiments include from the one particular value and/or to the other particular value. Furthermore, unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a process or method does not preclude the presence of additional steps or intervening steps between those steps expressly identified. Steps of a process or method may be performed in a different order than those described herein without departing from the scope of the disclosure. Similarly, it is also to be understood that the mention of one or more components in a process or system does not preclude the presence of additional components or intervening components between those components expressly identified.

The present disclosure relates to a process for the conversion of a lithium phosphate solution into a low phosphate containing lithium solution which is suitable as feedstock for the production of saleable lithium products, such as lithium carbonate or lithium hydroxide. The disclosure allows the recovery of the phosphate either for re-use to produce more lithium phosphate, or for other purposes. The disclosure also allows for the recovery and re-use of residual phosphate from a lithium-depleted solution resulting from a lithium phosphate precipitation process. The present disclosure is particularly suitable for the conversion of lithium phosphate that has been precipitated from a natural brine.

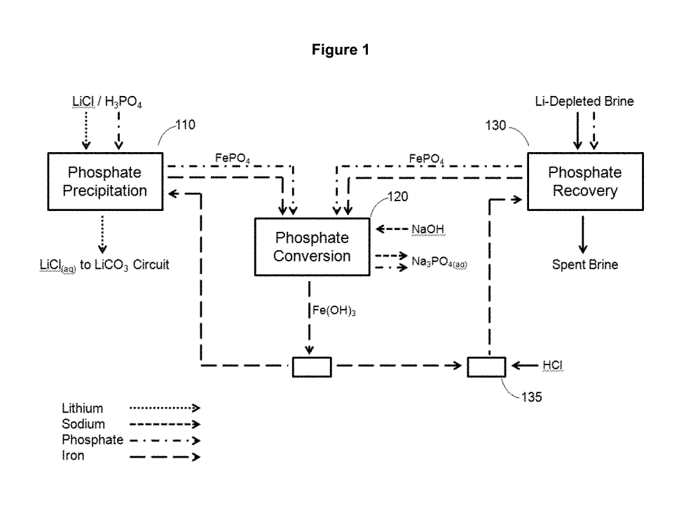

Referring to FIG. 1, there is shown a schematic representation of a phosphate precipitation, conversion and recovery process in accordance with an embodiment of the present disclosure. The process relies on the use of a phosphate carrier, which is an ion that forms an insoluble phosphate compound within a certain pH range, and that releases the phosphate, forming a hydroxide, at a higher pH, for example, when treated with sodium hydroxide (i.e. caustic soda). Examples of such phosphate carriers are Fe(III), and Mg(II), with Fe(III) being most preferred although the disclosure can include other ions that behave in a similar fashion.

The process broadly includes a phosphate precipitation step (110) in which an acidic solution of lithium and phosphate ions is treated with a hydroxide of a phosphate carrier (Fe(III)), thereby partially neutralising the solution and precipitating the phosphate of the phosphate carrier ion. A phosphate recovery step (130) is carried out whereby residual phosphate in a lithium depleted solution, resulting from the treatment of a lithium bearing solution with a phosphate to precipitate lithium phosphate, is also treated with a solution of the phosphate carrier to precipitate the phosphate of the phosphate carrier ion. Preferably, the solution of the phosphate carrier is a chloride of the phosphate carrier cation produced with the addition of hydrochloric acid (135). The precipitates of the phosphate precipitation step (110) and the phosphate recovery step (130) are subjected to treatment with a hydroxide base in a phosphate conversion step (120). The hydroxide base, such as sodium hydroxide, increases the pH such that the solid phosphate of the phosphate carrier ion converts to a solid hydroxide of the phosphate carrier ion. The solid hydroxide of the phosphate carrier ion may then be reused in the phosphate precipitation step (110) and the phosphate recovery step (130) as described above.

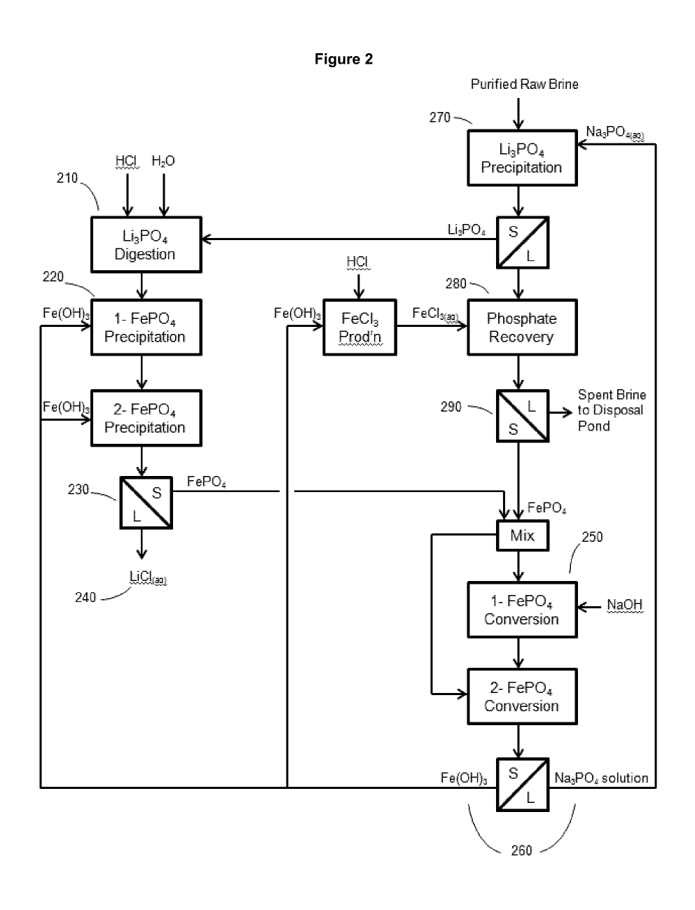

Referring to FIG. 2, there is shown a schematic representation of a lithium phosphate dissolution and phosphate recovery process and plant in accordance with an embodiment of the present disclosure. The process provides for the conversion of lithium phosphate into a phosphate-free lithium solution which is suitable as feedstock for the production of saleable lithium products, such as lithium carbonate or lithium hydroxide.

The process broadly includes steps of dissolving the lithium phosphate in acid (210), treating the resulting solution with the hydroxide of a phosphate carrier (220) ion such as iron(III) or magnesium(II) to precipitate the phosphate of the phosphate carrier ion, separating the precipitate of the phosphate and the phosphate carrier ion (230) to leave a low phosphate lithium solution suitable (240) for use for the production of saleable lithium products.

The phosphate precipitate is treated with a hydroxide base (250) such as sodium hydroxide or potassium hydroxide to regenerate a hydroxide of the phosphate carrier ion (260) for treating the acidic solution of dissolved lithium phosphate (220) and to produce a solution of phosphate suitable for re-use to produce more lithium phosphate (270). Some of the hydroxide of the phosphate carrier ion can be used to generate a solution of the phosphate carrier as a chloride to precipitate residual phosphate ions in lithium depleted brine solution (280) which is then separated before returning the brine solution to the environment (290).

The lithium phosphate which forms the starting material for this disclosure can be produced from the processing of mineral sources such as spodumene, petalite and lepidolite, seawater and from natural brines containing lithium such as those found in Salars in the Andes Mountains. Following the removal of target impurities, such as calcium, magnesium and boron ions, from a feed stock such as brine containing lithium ions, the recovery of lithium from the pre-treated brine can be performed by the lithium phosphate precipitation process. The lithium phosphate precipitation process includes treating the brine containing aqueous lithium (Li+) with a phosphorus containing reagent to form a lithium phosphate precipitate.

In order to precipitate a high proportion of the lithium, a certain concentration of phosphorous must be maintained. After separation of the lithium phosphate precipitate some phosphate remains in the lithium-depleted brine and needs to be recovered for re-use. This is because phosphorous containing reagent is expensive and because the brine containing phosphate cannot be returned to the environment.

Examples of such phosphate carriers are Fe(III), and Mg(II), with Fe(III) being most preferred although the disclosure can include other ions that behave in a similar fashion. The suitability of Fe(III) as a phosphate carrier ion is due to its propensity to precipitate as a phosphate at a lower pH and as a hydroxide at a higher pH. The reversible reaction of the phosphate carrier ion Fe(III) between an insoluble hydroxide compound and an insoluble phosphate compound, which is pH dependent, is represented by:

Fe(OH)₃ [symbol] FePO₄

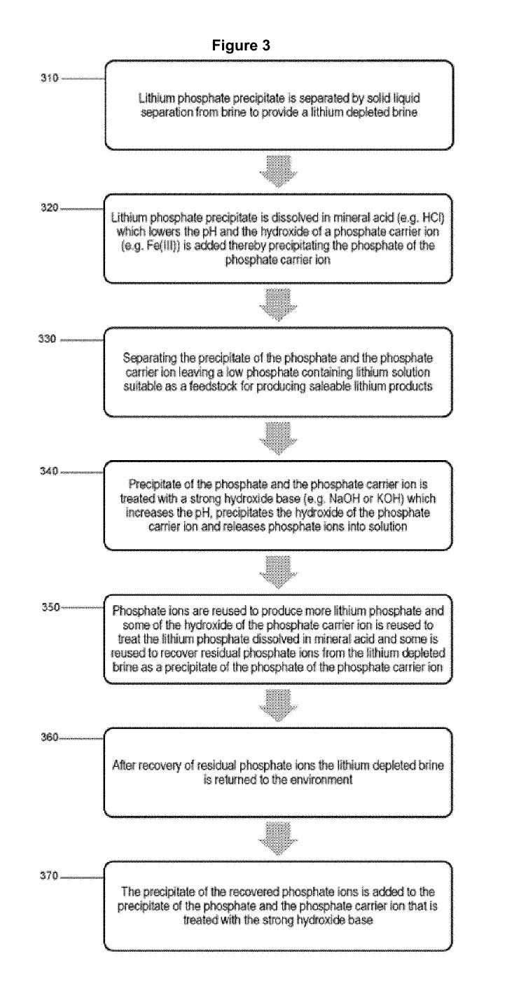

FIG. 3 illustrates an embodiment of the disclosure involving a process comprising a sequence of steps. The process includes a step of separating lithium phosphate precipitate from brine by solid/liquid separation (310).

Lithium phosphate precipitate is reacted (dissolved) with a mineral acid, such as hydrochloric acid, which lowers the pH of the solution, and a hydroxide of a phosphate carrier ion, such as iron(III), is added thereby precipitating the phosphate of the phosphate carrier ion (320). As a further example, if magnesium(II) were used instead of iron(III), then the resulting precipitate would be magnesium phosphate instead of iron (III) phosphate. Preferably, and as illustrated in FIG. 2, the reaction of the hydroxide of the phosphate carrier and the acidic lithium phosphate solution is allowed to take place in two stages at about 80° C. The pH in the first stage is preferably controlled in a range of about pH 1.25 to 1.5, thus precipitating about 90% of phosphorus in solution. The second stage is preferably controlled to a higher pH where the remainder of the phosphorus is precipitated to <10 mg/L. The pH of the second stage is dependent on the specific phosphate carrier being used. For example, if iron(III) is used as the phosphate carrier ion, the pH of the second stage would preferably be controlled to about pH 2.25 to 2.75. It is to be appreciated, however, that the although the addition of the hydroxide of the phosphate carrier ion does, at least to some extent, neutralise the acidic lithium phosphate solution the precipitation of the phosphate of the phosphate carrier ion may occur preferably at a relatively low pH range, being a pH of less than or equal to about the hydrolysis pH of the phosphate carrier ion being used. In the case of Fe(III), the precipitation of the phosphate of the phosphate carrier ion may occur preferably at about pH 2.75. In the case of Mg(II), the precipitation of the phosphate of the phosphate carrier ion may occur preferably at about pH 4.

The precipitate of the phosphate and the phosphate ion carrier, and any unreacted hydroxide, is separated from the solution containing lithium ions by a solid liquid separation process leaving a low phosphate containing lithium solution (330). The low phosphate containing lithium solution may be used as a feedstock to produce saleable forms of lithium such as lithium carbonate or lithium hydroxide. As a further example, if sulphuric acid were used instead of hydrochloric acid to dissolve the lithium phosphate then the resulting solution would contain lithium sulphate instead of lithium chloride.

The precipitate of the phosphate and the phosphate carrier ion is treated with a solution of a hydroxide base, such as NaOH(aq) or KOH(aq). This increases the pH and precipitates the hydroxide of the phosphate carrier ion and releases phosphate ions into the solution (340). For example, if the phosphate carrier was iron(III) and the strong base sodium hydroxide solution then solid iron(III) hydroxide and a solution of sodium phosphate would be formed.

Preferably, and as illustrated in FIG. 2, the treatment with sodium hydroxide is preferably performed in two stages at about 90° C. In the first stage the sodium hydroxide is preferably in large excess to ensure maximum conversion to ferric hydroxide and maximum phosphate dissolution. The second stage is preferably controlled to about 5 g/L excess sodium hydroxide by further addition of the phosphate precipitate to minimise the excess hydroxide present in the sodium phosphate solution. A high conversion of phosphate precipitate to hydroxide is achieved under these conditions.

The hydroxide of the phosphate carrier ion and the phosphate ions in solution are separated by solid liquid separation and the phosphate ions are reused to produce more lithium phosphate and the hydroxide of the phosphate carrier is reused to treat the lithium phosphate dissolved in mineral acid and some is reused to recover residual phosphate ions from the lithium depleted brine (350). The hydroxide of the phosphate carrier that is reused to recover residual phosphate is first reacted with mineral acid, such as hydrochloric acid, to form a low pH solution of the phosphate carrier ion. This solution is used to treat lithium depleted brine which has previously been treated with a phosphate supplying reagent to precipitate out lithium ions as lithium phosphate thus leaving the brine depleted of lithium but containing some residual phosphate. The treatment of the lithium depleted brine with the solution of the phosphate carrier ion precipitates out residual phosphate which can be separated from the brine by solid liquid separation which can then be returned to the environment (360).

In a preferred embodiment, the process involves the following steps:
(1) Dissolving lithium phosphate in acid to form a lithium phosphate-containing solution;
(2) Treating the lithium phosphate-containing solution with the hydroxide of the phosphate carrier ion, which leads to the neutralisation of the acid leading to a pH less than or equal to the hydrolysis pH of the phosphate carrier ion, which if the phosphate carrier ion is Fe(III) leads to a pH less than about pH 2.75, and the precipitation of the phosphate;
(3) Separating the phosphate precipitate leaving a substantially phosphate-free lithium solution;
(4) Treating the phosphate precipitate with a solution of a hydroxide base, such as NaOH(aq) or KOH(aq), at a relatively higher pH to convert the precipitate phosphate precipitate of the phosphate carrier ion into the hydroxide precipitate of the phosphate carrier ion and releasing the phosphate into the solution;
(5) Separating the hydroxide precipitate for use in Step (2), and leaving a phosphate solution suitable for re-use in a process to precipitate more lithium phosphate; and/or
(6) Residual phosphate remaining in a solution that has been depleted of lithium by the addition of phosphate and precipitation and separation of lithium phosphate is recovered by the addition of the phosphate carrier cation, preferably as a chloride (or sulphate), which precipitates the phosphate ions. The precipitated phosphate is then separated from the depleted lithium solution. The precipitated phosphate is in the same form as in process step 2 and can therefore be recycled to Step 4 to recover the phosphate.

The phosphate-free lithium solution may then be treated by conventional, or other, means to recover the lithium. For example, the remaining lithium solution may be treated with an alkali carbonate to precipitate lithium carbonate, or treated to produce lithium hydroxide.

### EXAMPLES

Various aspects of the disclosed solution may be still more fully understood from the following description of some example implementations and corresponding results. Some experimental data is presented herein for purposes of illustration and should not be construed as limiting the scope of the disclosed technology in any way or excluding any alternative or additional embodiments.

### Example 1—General Process

A first example of certain implementations of the disclosed technology and corresponding results will now be described with respect to a brine solution composed of 1.2 g/L Ca, 10.0 g/L K, 4.3 g/L Mg, 114 g/L Na, 3.2 g/L S, 190 g/L Cl, 440 mg/L Li and 350 mg/L B that was treated for lithium recovery.

The brine was first treated with sodium hydroxide and sodium carbonate to precipitate both the magnesium and calcium to <10 mg/L.

After solid/liquid separation the solution was then heated to >100° C. and then a 100-200 g/L solution of sodium phosphate was added to precipitate lithium phosphate. The Li precipitation is dependent on the residual P (phosphorus) in solution. Nominally 70 to 85% of the lithium is precipitated as lithium phosphate. The resultant solution contained 400 mg/L of phosphorous, which concentration was required to ensure a high degree of lithium precipitation.

The lithium-depleted solution was then treated with a stoichiometric quantity of ferric chloride solution, with the pH controlled between pH 4 and 7, to produce an iron precipitate. The residual P was <5 mg/L.

The lithium phosphate was dissolved in a stoichiometric quantity of hydrochloric acid to produce a solution containing 35-40 g/L Li.

This solution was treated with ferric hydroxide slurry in two stages at 80° C., to produce an iron precipitate. The pH in the first stage was controlled to pH 1.25 to 1.5 and precipitated ˜90% of the phosphorus. The second stage was controlled to pH 2.25 to 2.75, where the remainder of the phosphorus was precipitated to <10 mg/L.

The iron precipitates were mixed and treated with a sodium hydroxide solution at 90° C. in a two stage process. In the first stage the sodium hydroxide was in excess to ensure maximum conversion to ferric hydroxide (and maximum phosphate dissolution). The second stage was controlled to ˜5 g/L excess hydroxide by further addition of the ferric phosphate precipitate to minimise the excess hydroxide present in the sodium phosphate solution. A conversion of ferric phosphate to ferric hydroxide of >95% was achieved.

The above steps were repeated a number of times to new treated brine solutions without the addition of any new ferric hydroxide or ferric phosphate. The results were similar for each cycle. Thus, a locked cycle test was achieved and shown to be successful, proving the suitability of Fe(III) as a phosphate carrier ion.

It is to be appreciated that similar parameters may be applied to a magnesium system, where magnesium is used as the phosphate carrier ion in place of iron (III). In the case of a magnesium system, the main differences to the ferric system, and embodiments thereof described herein, are in the control of the pH of the system.

For example, in a magnesium system, in the phosphate recovery step after the lithium phosphate precipitation, the magnesium chloride addition reaction takes place at a higher pH than the equivalent reaction in the ferric system, e.g. at pH 10 or above. Hydrochloric acid can then be added to reduce the pH to neutral in the spent brine.

In the phosphate precipitation step after the lithium phosphate dissolution, the magnesium hydroxide can be added in two stages with the pH being controlled at about pH 4 in the first stage and about pH 5-6 in the second stage to achieve high phosphorus precipitation.

In the magnesium phosphate precipitate conversion to magnesium hydroxide and sodium phosphate step, the pH and temperature is similar to the ferric equivalent. The magnesium phosphate conversion is slightly lower at >90%. However the pH can be raised to increase the percentage of magnesium phosphate that reacts.

### Example 2—Ferric Phosphate Precipitation

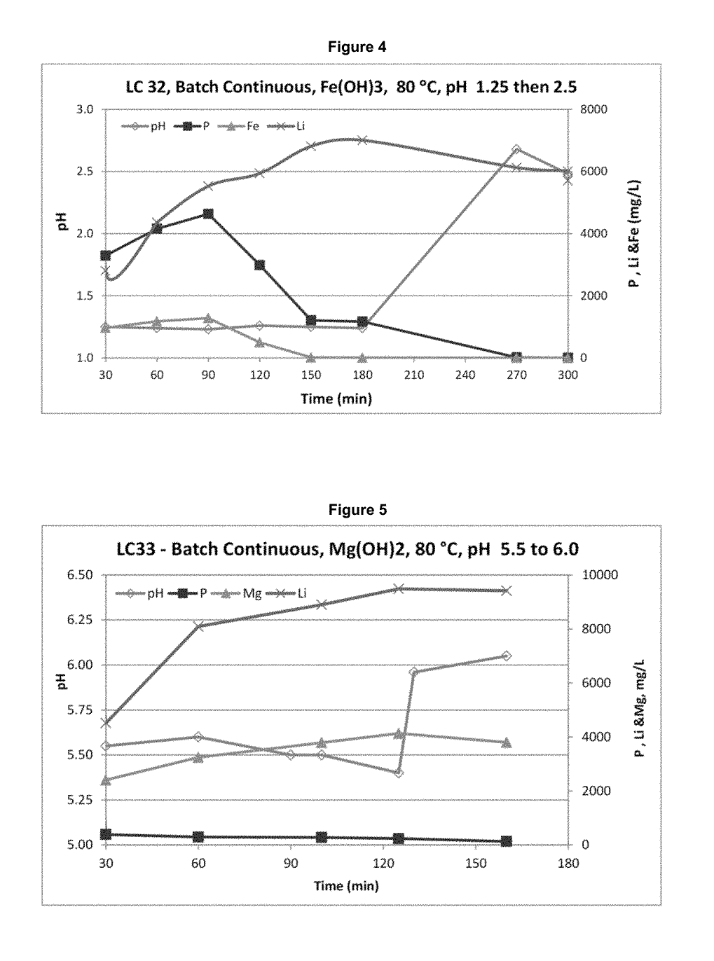

In this second example, the efficacy of ferric hydroxide as the phosphate carrier was quantitatively tested in the step of treating the lithium phosphate bearing solution to form a ferric phosphate precipitate. Details of the concentrations of free phosphorous, iron and lithium ions, and the pH of the solution, over the course of this experiment can be found in FIG. 4.

An initial amount of lithium phosphate precipitate was added with hydrochloric acid to provide a solution of phosphoric acid and lithium phosphate. The phosphorus precipitation was then conducted in two stages, both controlled to 80° C.

In stage 1 (time 0-180 min), ferric hydroxide filter cake and the solution were simultaneously added to a vessel, containing a small heel of solution at pH 1.25. The phosphate solution was added at a set flowrate over 180 minutes while the ferric hydroxide addition was controlled to maintain pH 1.25. Approximately 95% of the ferric hydroxide was added in this stage.

As shown in FIG. 4, the addition of ferric hydroxide significantly increased the free lithium ions in the solution as a ferric phosphate precipitate was formed. While the skilled person would appreciate that the lithium may be extracted to be processed into a saleable form after this first stage, the inventors have found that the solution may be further treated in a second stage to provide additional recovery and recycling capabilities for the phosphorous in solution.

Accordingly, in stage 2 (time 180-300 min), further ferric hydroxide was added to raise the pH to 2.5 over 0.5 hours and then controlled at that pH for a further 1.5 hours. This addition of further ferric hydroxide caused a decrease in the phosphorous in solution from 1100 mg/L to 2 mg/L. The ferric ion concentration in solution was <5 mg/L throughout stage 2.

### Example 3—Magnesium Phosphate Precipitation

In this third example, the efficacy of magnesium hydroxide as the phosphate carrier was quantitatively tested in the step of treating the lithium phosphate bearing solution to form a magnesium phosphate precipitate. Details of the concentrations of free phosphorous, magnesium and lithium ions, and the pH of the solution, over the course of this experiment can be found in FIG. 5.

An initial amount of lithium phosphate precipitate was added with hydrochloric acid to provide a solution of phosphoric acid and lithium phosphate. The phosphorus precipitation was then conducted in two stages, both controlled to 80° C.

In stage 1 (time 0-125 min), magnesium hydroxide filter cake and the solution were simultaneously added to a vessel, containing a small heel of solution at pH 5.5. The phosphate solution was added at a set flowrate over 125 minutes while the magnesium hydroxide addition was controlled to maintain pH 5.5. Approximately 85% of the magnesium hydroxide was added in this stage.

As shown in FIG. 5, the addition of magnesium hydroxide significantly increased the free lithium ions in the solution as a magnesium phosphate precipitate was formed. Similar to the ferric phosphate example, the skilled person would appreciate that the lithium may be extracted to be processed into a saleable form after this first stage; however, the solution may also be further treated in a second stage to provide additional recovery and recycling capabilities for the phosphorous in solution.

Accordingly, in stage 2 (time 125-160 min), more magnesium hydroxide was added to raise the pH to 6.0 and then controlled at that pH for a further 30 minutes. This addition of further magnesium hydroxide caused a decrease in the phosphorous in solution from 235 mg/L to 126 mg/L. The remaining magnesium in solution after stage 2 was 1460 mg/L.

In further tests (not shown) conducted by adding stoichiometric amounts of magnesium hydroxide, it was found that the phosphorus concentration in solution could be reduced to <50 mg/L; however, the magnesium in solution was higher than in the above test.

### Example 4—Phosphate Recovery

In this fourth example, the optimisation of phosphate recovery conditions was tested.

A solution of spent brine (after the lithium phosphate precipitation step) was placed in a reaction vessel. A 230 g/L ferric chloride solution was slowly added to the spent brine over a four hour period at ambient temperature. As the ferric chloride was added, a precipitate formed and the pH slowly decreased. Solution samples were taken every 15 minutes and the pH monitored throughout.

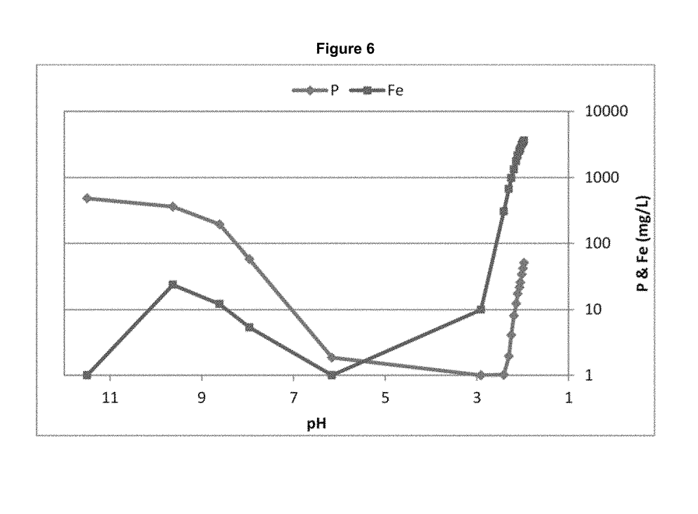

The solution analyses, particularly the concentrations of phosphorous and iron ions in solution, have been plotted against pH in the FIG. 6.

As shown in FIG. 6, the ferric chloride gradually reduced the pH of the brine solution by forming ferric hydroxide. The ferric chloride also decreased the phosphate in solution by precipitating it as ferric phosphate. The graph shows that at pH 6.2 the phosphorus in solution was reduced to 2 g/L, and remained low (as did the iron) until the pH dropped to below 2.5.

These results indicate a preferable operating window for phosphate recovery of between pH 2.5 and 6.2. It also indicates that the preferable operating pH for stage 2 of ferric phosphate precipitation is pH 2.5, as at that pH the iron and phosphorus in solution was minimal.

Any of the herein described components and processes discussed may take on various forms to provide and meet the environmental, structural demands, and operational requirements. The specific configurations can be varied according to particular design specifications or constraints requiring a process or system according to the principles of the disclosed technology. Such changes are intended to be embraced within the scope of the disclosed technology. The presently disclosed embodiments, therefore, are considered in all respects to be illustrative and not restrictive. The scope of the present solution is indicated by the appended claims, rather than the foregoing description, and all changes that come within the meaning and range of equivalents thereof are intended to be embraced therein.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such combinations, alterations, modifications and variations that fall within the spirit and scope of the appended claims.

1. A process for converting lithium phosphate into a low-phosphate solution containing lithium which is suitable as feedstock for the production of saleable lithium products, the process comprising:
dissolving the lithium phosphate in acid to form an acidic lithium phosphate bearing solution;
treating the acidic lithium phosphate bearing solution with a hydroxide of a phosphate carrier to form a precipitate of phosphate and the phosphate carrier; and
separating the precipitate of phosphate and the phosphate carrier leaving a low-phosphate solution containing lithium.

2. The process of claim 1, further comprising: treating the precipitate of phosphate and the phosphate carrier with a hydroxide base to convert the phosphate carrier to a precipitate of hydroxide and the phosphate carrier.

3. (canceled)

4. The process of claim 2, wherein the treatment with the hydroxide base is carried out at a temperature higher than ambient temperature.

5-7. (canceled)

8. The process of claim 2, wherein the treatment with the hydroxide base is carried out at an acidic pH.

9-12. (canceled)

13. The process of claim 2, wherein the treatment with the hydroxide base is carried out in two stages.

14. The process of claim 13, wherein the first stage and/or the second stage of treatment with the hydroxide base are carried out at a temperature higher than ambient temperature.

15. The process of claim 13, wherein the first stage and/or the second stage of treatment with the hydroxide base are carried out at a temperature about 70° C. to about 200° C.

16-17. (canceled)

18. The process of claim 13, wherein the first stage and/or the second stage of treatment with the hydroxide base are carried out at an acidic pH.

19. The process of claim 13, wherein the first stage and/or the second stage of treatment with the hydroxide base are carried out at a pH<2.75.

20. (canceled)

21. The process of claim 13, wherein the pH in the second stage is controlled to a pH greater than the pH of the first stage.

22. (canceled)

23. The process of claim 2, wherein treating the precipitate of phosphate and the phosphate carrier with a hydroxide base releases the phosphate into solution for re-use in a process to produce lithium phosphate.

24. The process of claim 2, wherein the precipitate of hydroxide and the phosphate carrier is separated and at least some of the phosphate carrier is re-used in the step of treating the acidic lithium phosphate bearing solution to form the precipitate of phosphate and the phosphate carrier.

25. The process of claim 2, wherein the precipitate of hydroxide and the phosphate carrier is separated and at least some of the phosphate carrier is dissolved in acid to form a solution of the phosphate carrier ion.

26. The process of claim 25, wherein the solution of the phosphate carrier ion is used to treat a solution containing residual phosphate from which the lithium phosphate has been separated prior to being dissolved in acid whereby the phosphate carrier forms a precipitate of the residual phosphate and the phosphate carrier.

27. The process of claim 26, wherein the solution containing residual phosphate is a brine and the precipitate of the residual phosphate and the phosphate carrier is separated from the brine, thereby leaving the brine substantially phosphate free for return to the environment.

28. The process of claim 27, wherein the precipitate of the residual phosphate and the phosphate carrier separated from the brine is treated with the hydroxide base.

29. The process of claim 1, wherein the phosphate carrier comprises an ion that forms an insoluble phosphate compound within a certain pH range and that releases the phosphate and forms an insoluble hydroxide compound at a higher pH.

30. The process of claim 1, wherein the phosphate carrier ion is iron (lll).

31. The process of claim 1, wherein the phosphate carrier ion is magnesium (II).

32. (canceled)

33. The process of claim 1, wherein the phosphate carrier ion is an ion of a rare earth element.

34-38. (canceled)
